(19) United States
(12) Patent Application Publication
(10) Pub. No.: US 2025/0335678 A1
(43) Pub. Date: Oct. 30, 2025

(54) DETERMINING AN OPERATIONAL LIMIT FOR A CIRCUIT COMPONENT

(71) Applicant: Microchip Technology Incorporated, Chandler, AZ (US)

(72) Inventors: Mazhar Hoque, Gilbert, AZ (US); Amit G. Rai, Chandler, AZ (US); Samir Fuke, Tempe, AZ (US); Joseph Rascon, Chandler, AZ (US); Randy Yach, Phoenix, AZ (US); Jerry Patel, Plano, TX (US); Vaibhav Dubey, Hyderabad (IN); Hoi Yun Henry Chan, Lachine (CA)

(73) Assignee: Microchip Technology Incorporated, Chandler, AZ (US)

(21) Appl. No.: 18/810,767

(22) Filed: Aug. 21, 2024

(30) Foreign Application Priority Data
Apr. 30, 2024 (IN) 202411034408

(51) Int. Cl. G06F 30/3308

(52) U.S. Cl. CPC G06F 30/3308

(57) ABSTRACT

A non-transitory computer-readable medium comprising instructions executable by a processor to receive a set of input parameters related to a circuit component and perform an age-dependent analysis of the circuit component based on the set of input parameters. The age-dependent analysis of the circuit component includes performing a series of automated simulations of a non-aged model of the circuit component using each of multiple values of a first operational parameter, performing a series of automated simulations of an aged model of the circuit component using each of the multiple values of the first operational parameter, and comparing respective results of the automated simulations of the non-aged and aged models of the circuit component. The instructions are further executable to determine an operational limit for the circuit component based at least on the age-dependent analysis of the circuit component.

### RELATED APPLICATION

This application claims priority to Indian Provisional Patent Application No. 202411034408 filed Apr. 30, 2024, the entire contents of which application are hereby incorporated by reference for all purposes.

### TECHNICAL FIELD

The present disclosure relates to determining an operational limit for a circuit component.

### BACKGROUND

The performance of electronic circuit components, for example transistors and other semiconductor devices, typically degrades over time due to one or more factors, for example time-dependent dielectric breakdown (TDDB), hot carrier injection (HCI), and/or bias temperature instability (BTI), without limitation. This age-dependent degradation is particularly significant in certainly advanced semiconductor process technology nodes, for example technologies of 55 nm and below.

A circuit designer or manufacturer using an Electronic Design Automation (EDA) tool (for example a Cadence, Synopsys, or Ansys EDA platform) to design a circuit, may attempt to determine operational ranges for respective circuit components (e.g., transistors) that allow for long-term operation with acceptable age-related degradation. Such operational range is often referred to as a safe operating area (SOA), the extents of which are referred to as SOA limits. Conventional techniques for determining SOA limits include using a spreadsheet (e.g., Excel) or other online calculator. Such techniques are generally primitive, providing a rough estimate of SOA limits, and often inaccurate. Conventional techniques typically involve checking the performance of each circuit components by a largely manual process, performed outside the relevant design environment, e.g., outside the EDA tool used for the relevant circuit design. This largely manual checking of circuit components may be slow and time consuming.

Conventional tools often require a separate calculation process for each mode of degradation, e.g., BTI and HCI, and cannot analyze BTI and HCI collectively. In addition, conventional tools typically cannot check a recovery factor for BTI. In addition, for transistor design, conventional tools typically provide a generic maximum operational voltage, without differentiating between drain-source voltage (Vds) and gate-source voltage (Vgs), and typically cannot provide a maximum body-source voltage (Vbs).

Conventional EDA tools typically have some capability to run aging simulations, but such simulations can be time-consuming. In addition, such aging simulations are typically performed at the end of the circuit design cycle, thus often requiring an extensive redesign of the circuit in response to the aging simulation results. Also, such aging simulations typically do not include TDDB analysis, which requires signals to remain within duration-dependent signal limits. Still further, EDA tools typically do not have capability to generate maximum allowable voltage limits for a specific application.

There is a need for improved systems and methods for generating operational limits (e.g., SOA limits) for respective circuit components (e.g., a transistor) and using such operational limits to analyze a circuit design.

### SUMMARY

The present disclosure provides automated systems and methods of generating operational limits for circuit components, e.g., transistors, based on predicted aging or degradation effects in circuit performance for a specified application of respective circuit components. The operational limits, also referred to as safe operating area (SOA) limits, may then be used to check a circuit design for compliance, e.g., during various stages of the circuit design. In some examples, such systems and methods may be integrated in an Electronic Design Automation (EDA) tool.

For example, a system and method disclosed herein may determine a maximum allowable voltage limit for particular transistor based on predicted aging/degradation in performance of the transistor over a specified set of operational parameters. The maximum voltage limit can then be used to check a circuit design within a design environment (e.g., within an EDA tool) to ensure the design is compliant with the allowable voltage limit, e.g., to ensure the circuit can perform within desired specifications over its intended lifetime.

The disclosed systems and methods may provide various advantages over certain conventional systems and methods. For example, unlike typical conventional processing in which aging simulation is performed at the top hierarchical level of a circuit design block, according to disclosed methods, a circuit can be checked for compliance with operational limits (e.g., maximum voltage limits) at lower-level schematics in the design cycle during the process of building up the blocks, which may help avoid extensive changes/corrections that are often required when aging simulations are done at the top level. This may thereby reduce multiple iterations of circuit design.

As another example, disclosed systems and methods may be integrated into an EDA tool, which may allow designers to determine operational limits and check a circuit design for compliance within the design environment.

As another example, disclosed systems and methods may increase the efficiency of a circuit design process, for example by eliminating resource/time from a reliability team to generate SOA limits and a CAD team to implement SOA checks.

As another example, disclosed systems and methods may determine Vₘₐₓ limits for Vds, Vgs, and Vbs for a transistor. In other words, separate voltage limits can be generated for different transistor terminals (drain, gate, body, source), as opposed to a single maximum voltage limit for the transistor.

As another example, disclosed systems and methods may provide capability robustness. For example, SOA limits can be momentarily generated based on specific use case of geometry, temperature, lifetime and failure rate (e.g., ppm) and failure criteria in terms of ΔVtlin, ΔIdsat, and/or ΔIdlin.

One aspect provides a non-transitory computer-readable medium comprising instructions executable by a processor to receive a set of input parameters related to a circuit component, and perform an age-dependent analysis of the circuit component based on the set of input parameters. The age-dependent analysis may include performing a non-aging simulation of the circuit component by simulating a non-aging operation of the circuit component; performing a series of aging simulations of the circuit component, each aging simulation comprising a simulation of an aging operation of the circuit component based on (a) aging conditions specified by the input parameters and (b) a different value of at least one operational parameter of the circuit component; and comparing respective results of the series of aging simulations with a result of the non-aging simulation. The instructions may be further executable to determine an operational limit for the circuit component based at least on a result of the age-dependent analysis of the circuit component.

In some examples, the instructions are further executable by the processor to apply the operational limit to a circuit design to detect design violations.

In some examples, the operational limit comprises a safe operating area (SOA) limit for the circuit component.

In some examples, the non-aging simulation and the aging simulations of the circuit component are performed by a SPICE simulator.

In some examples, each aging simulation in the series of aging simulations of the circuit component comprises a simulation of an aging operation of the circuit component based on (a) the aging conditions specified by the input parameters and (b) a different parameter value combination for at least two operational parameters of the circuit component.

In some examples, performing the series of aging simulations of the circuit component comprises performing multiple aging simulations of the circuit component for each of multiple different values of a first operational parameter of the circuit component, wherein the multiple aging simulations for a respective value of the first operational parameter comprises respective aging simulations based on (a) the aging conditions specified by the input parameters, (b) the respective value of the first operational parameter, and (c) multiple different values of a second operational parameter of the circuit component; the age-dependent analysis comprises determining, for each of at least two of the multiple different values of the first operational parameter, a respective limit value derived from results of the multiple aging simulations performed for the respective value of the first operational parameter; and determining the operational limit for the circuit component based at least on a result of the age-dependent analysis of the circuit component comprises selecting a highest or lowest value of the at least two limit values as the operational limit for the circuit component.

In some examples, the circuit component comprises a transistor, and the at least one operational parameter of the circuit component comprises at least one of a gate-source voltage (Vgs), a drain-source voltage (Vds), or a body-source voltage (Vbs).

In some examples, the non-aging simulation of the circuit component comprises simulating an effect of the non-aging operation of the circuit component on a performance metric specified in the set of input parameters; and each respective aging simulation of the circuit component comprises simulating an effect of the aging operation of the circuit component on the specified performance metric.

In some examples, the circuit component comprises a transistor; the at least one operational parameter of the circuit component comprises at least one of a gate-source voltage (Vgs), a drain-source voltage (Vds), or a body-source voltage (Vbs); and the specified performance metric comprise a saturation drain current (Idsat), a linear drain current (Idlin), or a linear threshold voltage (Vtlin).

In some examples, performing the non-aging simulation of the circuit component comprises simulating a non-aging operation of a non-aged model of the circuit component derived from the set of input parameters; and performing a respective aging simulation of the circuit component in the series of aging simulations comprises (a) simulating an aging operation of the non-aged model of the circuit component, (b) generating an aged model of the circuit component based on results of the simulated aging operation of the non-aged model of the circuit component, and (c) simulating an operation of the aged model of the circuit component.

One aspect provides a non-transitory computer-readable medium comprising instructions executable by a processor to receive a set of input parameters related to a transistor and perform an age-dependent analysis of the transistor. The age-dependent analysis may include performing a non-aging simulation of the circuit component by simulating a non-aging operation of the circuit component to determine a non-aged value of a performance metric, and performing a series of aging simulations of the circuit component, wherein performing each respective aging simulation in the series of aging simulations comprises simulating an aging operation of the circuit component, using (a) aging conditions specified by the input parameters and (b) a respective value of multiple different values of a first operational parameter of the circuit component, to determine a respective aged value of the performance metric corresponding with the respective value of the first operational parameter. The age-dependent analysis may compare, for each respective aging simulation, (a) the respective aged value of the performance metric corresponding with the respective value of the first operational parameter with (b) with the non-aged value of a performance metric to determine a respective aging-based change in the performance metric corresponding with the respective value of the first operational parameter. The age-dependent analysis may determine, based on the respective aging-based changes in the performance metric corresponding with the respective values of the first operational parameter, a limit value of the first operational parameter corresponding with a threshold value of the performance metric. The instructions may be further executable to determine an operational limit for the circuit component based at least on the determined limit value of the first operational parameter.

In some examples, the instructions are further executable by the processor to apply the operational limit to a circuit design to detect design violations.

In some examples, the operational limit comprises a safe operating area (SOA) limit for the circuit component.

In some examples, performing the series of aging simulations of the circuit component comprises performing multiple aging simulations of the circuit component for each of the multiple different values of the first operational parameter of the circuit component, wherein the multiple aging simulations for the respective value of the first operational parameter comprises respective aging simulations based on (a) the aging conditions specified by the input parameters, (b) the respective value of the first operational parameter, and (c) multiple different values of a second operational parameter of the circuit component; the age-dependent analysis comprises determining, for each of at least two of the multiple different values of the first operational parameter, a respective limit value derived from results of the multiple aging simulations performed for the respective value of the first operational parameter; and determining the operational limit for the circuit component based at least on a result of the age-dependent analysis of the circuit component comprises selecting a highest or lowest value of the at least two limit values as the operational limit for the circuit component.

In some examples, the circuit component comprises a transistor, and the first operational parameter comprises a gate-source voltage (Vgs), a drain-source voltage (Vds), or a body-source voltage (Vbs).

In some examples, the non-aging simulation of the circuit component comprises simulating an effect of the non-aging operation of the circuit component on a performance metric specified in the set of input parameters; and each respective aging simulation of the circuit component comprises simulating an effect of the aging operation of the circuit component on the specified performance metric.

In some examples, the circuit component comprises a transistor; the first operational parameter of the circuit component comprises a gate-source voltage (Vgs), a drain-source voltage (Vds), or a body-source voltage (Vbs); and the specified performance metric comprise a saturation drain current (Idsat), a linear drain current (Idlin), or a linear threshold voltage (Vtlin).

One aspect provides a method, including receiving a set of input parameters related to a circuit component, and performing an age-dependent analysis of the circuit component based on the set of input parameters. The age-dependent analysis may include performing a non-aging simulation of the circuit component by simulating a non-aging operation of the circuit component, performing a series of aging simulations of the circuit component, each aging simulation comprising a simulation of an aging operation of the circuit component based on (a) aging conditions specified by the input parameters and (b) a different value of at least one operational parameter of the circuit component, and comparing respective results of the series of aging simulations with a result of the non-aging simulation. An operational limit for the circuit component is determined based at least on a result of the age-dependent analysis of the circuit component.

One aspect provides a system including an electronic design automation (EDA) tool for facilitating a development of circuit design including a circuit component, and an operational limit generation system integrated in the EDA tool. The operational limit generation system including instructions stored in non-transitory computer-readable medium and executable by a processor to (a) receive a set of input parameters related to a circuit component, (b) perform an age-dependent analysis of the circuit component based on the set of input parameters, including performing a non-aging simulation of the circuit component by simulating a non-aging operation of the circuit component, performing a series of aging simulations of the circuit component, each aging simulation comprising a simulation of an aging operation of the circuit component based on (a) aging conditions specified by the input parameters and (b) a different value of at least one operational parameter of the circuit component, and comparing respective results of the series of aging simulations with a result of the non-aging simulation, and (c) determine an operational limit for the circuit component based at least on a result of the age-dependent analysis of the circuit component.

### BRIEF DESCRIPTION OF THE DRAWINGS

Example aspects of the present disclosure are described below in conjunction with the figures, in which:

FIG. 1 illustrates an example system for generating and analyzing circuit designs using operational limits (e.g., SOA limits) for respective circuit components;

FIG. 2 illustrates an example operational limit generation system for generating an operational limit (e.g., an SOA limit) for a respective circuit component (e.g., transistor), which may be used to check a circuit design;

FIG. 3 shows a flowchart of an example process for generating an operational limit (e.g., maximum operating voltage) for a circuit component (e.g., a transistor);

FIG. 4 shows a flowchart of another example process for generating an operational limit (e.g., maximum operating voltage) for a circuit component (e.g., a transistor);

FIG. 5 shows a flowchart of an example process for determining an operational limit (Vₘₐₓ) for an example transistor; and

FIGS. 6A-6G show example graphs illustrating various aspects of the example process shown in FIG. 5.

It should be understood that the reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

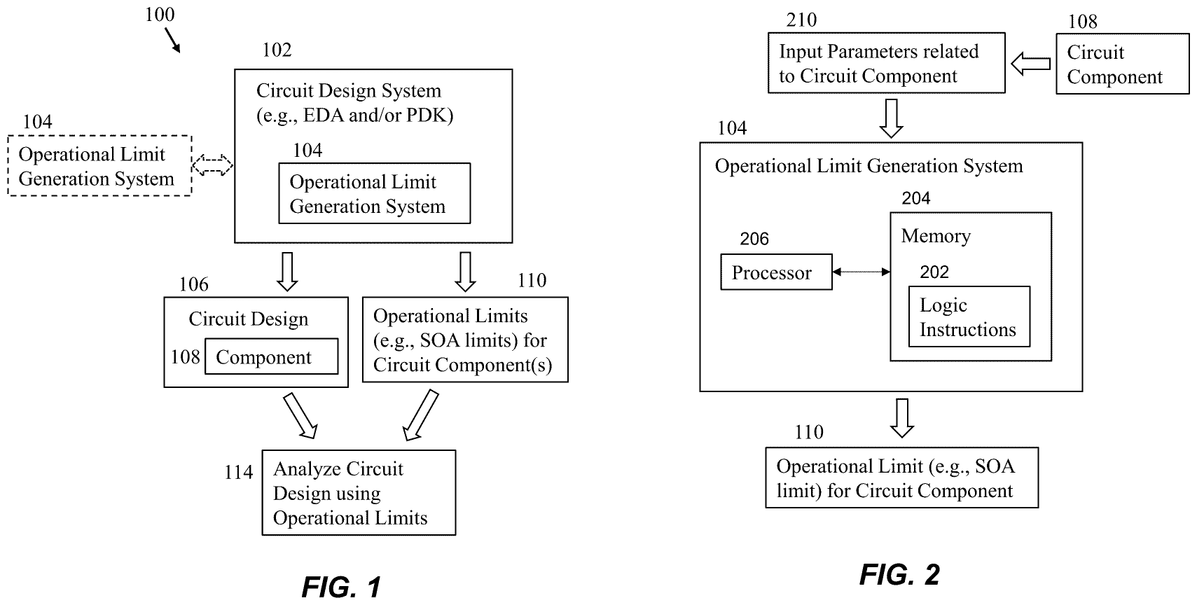

FIG. 1 illustrates an example system 100 for generating and analyzing circuit designs using operational limits (e.g., SOA limits) for respective circuit components. The example system 100 may include a circuit design system 102 and an operational limit generation system 104. The circuit design system 102 may include any automated or semi-automated system or systems for generating and analyzing a circuit design 106 including various circuit components 108 (e.g., transistors), for example, an electronic design automation (EDA) tool (for example a Cadence, Synopsys, or Ansys EDA platform) to build and analyze circuit designs and/or a physical design kit (PDK) specific to a particular application or technology.

The operational limit generation system 104 may include circuitry to generate operational limits 110 (e.g., SOA limits) for respective circuit components 108 in the circuit design 106. The operational limit generation system 104 may generate operational limits 110 for respective circuit components 108 based on respective input parameters (e.g., voltage specifications, operating temperature, minimum lifetime, maximum failure rate, etc.). The circuit design system 102 may utilize operational limits 110 generated by the operational limit generation system 104 to check the circuit design 106 for compliance (e.g., at various stages during the construction of the circuit design 106), as indicated at 114.

As discussed below with respect to FIG. 2, the operational limit generation system 104 may comprise software or other computer-executable instructions stored in memory and executable by one or more processors. In some examples, the operational limit generation system 104 may be integrated in the circuit design system 102 (e.g., integrated in an EDA tool). In other examples, the operational limit generation system 104 may be separate from the circuit design system 102.

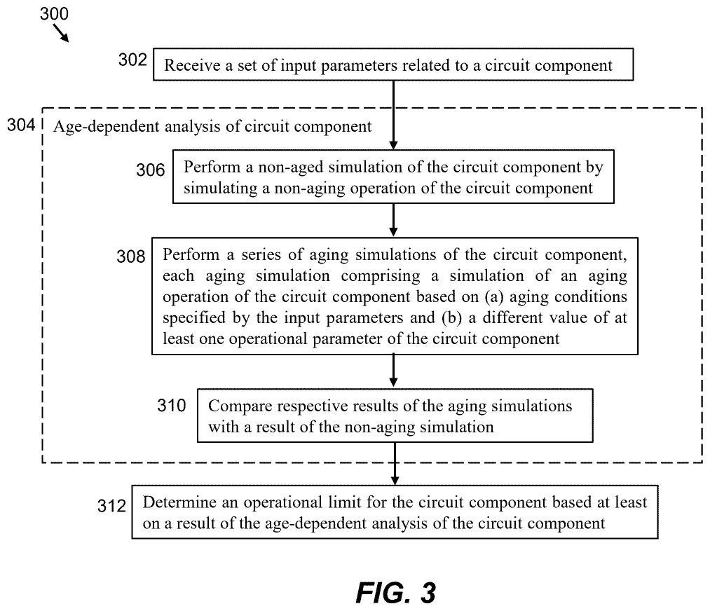

FIG. 2 illustrates an example operational limit generation system 104 for generating an operational limit 110 (e.g., an SOA limit) for a respective circuit component 108 (e.g., transistor), which operational limit 110 may be used by a circuit design system 102 to check a circuit design 106, as discussed above. As shown, the operational limit generation system 104 may include computer-readable logic instructions 202 (e.g., embodied in software and/or firmware) stored in memory 204 and executable by a processor 206 to perform a respective process to generate the operational limit 110, for example any of the example processes shown in FIGS. 3-5 and discussed below.

Memory 204 may include one or more type of memory device to store logic instructions 202, for example, read-only memory (ROM), random access memory (RAM, SRAM, DRAM), electrically erasable programmable read-only memory (EEPROM), a PCMCIA card, flash memory, magnetic storage, opto-magnetic storage, hardware registers, and/or any suitable selection or array of volatile or non-volatile memory. Processor 206 may comprise any system, device, or apparatus operable to interpret or execute logic instructions 202, and may include, without limitation a microprocessor, microcontroller, digital signal processor (DSP), application specific integrated circuit (ASIC), or any other digital or analog circuitry to interpret or execute program instructions and/or process data.

As shown in FIG. 2, the operational limit generation system 104 may receive input parameters 210 related to the circuit component 108 (e.g., transistor), and generate an operational limit 110 (e.g., a maximum gate voltage) for the circuit component 108. FIGS. 3-5 discussed below illustrate example processes implemented by the operational limit generation system 104 (e.g., by execution of logic instructions 202 by processor 206) to generate an example operational limit 110 based on example input parameters 210.

FIG. 3 shows a flowchart of an example process 300 for generating an operational limit (e.g., maximum operating voltage) for a circuit component (e.g., transistor). The example process 300 may be implemented by the operational limit generation system 104 shown in FIG. 2, for example by execution of respective logic instructions 202 (e.g., software) by a processor 206.

At 302, the operational limit generation system 104 may receive a set of input parameters 210 related to a particular circuit component 108, e.g., a particular transistor to be included in a circuit design 106 for a particular application. Input parameters 210 may include, for example, characteristics of the circuit component 108 itself (e.g., size, operating specifications, etc.), parameters related to an expected operation of the circuit component 108 (e.g., temperature), and/or “aging conditions” related to the circuit component 108 (e.g., a target lifetime, a failure rate, and/or particular failure mode(s) to be analyzed).

At 304, the operational limit generation system 104 may perform an age-dependent analysis of the circuit component 108 based on the set of input parameters 210. The age-dependent analysis may include steps 306-310, which may be performed in any order and may be performed at least partially simultaneously.

At 306, the operational limit generation system 104 may perform a non-aging simulation of the circuit component 108 by simulating a non-aging operation of the circuit component 108, for example, based on one or more of the input parameters 210, for example using a SPICE circuit simulator program. Simulating a non-aging operation of the circuit component 108 may include (a) generating a model of a freshly manufactured instance of the circuit component 108, referred to as a “non-aged model” of the circuit component 108, based on respective input parameters 210 (e.g., dimensions, materials, operating specifications, etc. of the circuit component 108), and (b) operating the non-aged model according to respective input parameters 210 (e.g., Vdd, use temperature, etc.), and without considering time-based degradation (i.e., aging) of the circuit component 108, to determine a resulting value of a target performance metric (e.g., a saturation current Idsat) specified by the input parameters 210.

At 308, the operational limit generation system 104 may perform a series of aging simulations of the circuit component 108. Each aging simulation may comprise an extended simulation of an aging operation of the circuit component 108 based on (a) aging conditions specified by the input parameters and (b) selected value(s) of at least one operational parameter of the circuit component 108, to determine a respective value of the target performance metric (e.g., a saturation current Idsat) resulting from such simulated operation. In one example, the operational limit generation system 104 may use a SPICE circuit simulator program or other suitable program(s) to (a) apply selected operational parameter value(s) (e.g., Vds, Vgs, temperature, etc.) to the circuit component 108 for the target lifetime specified by the input parameters 210, which may alter certain characteristics of the circuit component 108 (e.g., gate oxide charge, electron/hole mobility, etc.), (b) generate an “aged model” of the circuit component 108 based on such altered characteristics of the circuit component 108, and (c) operate the aged model to determine a value of the target performance metric (e.g., Idsat).

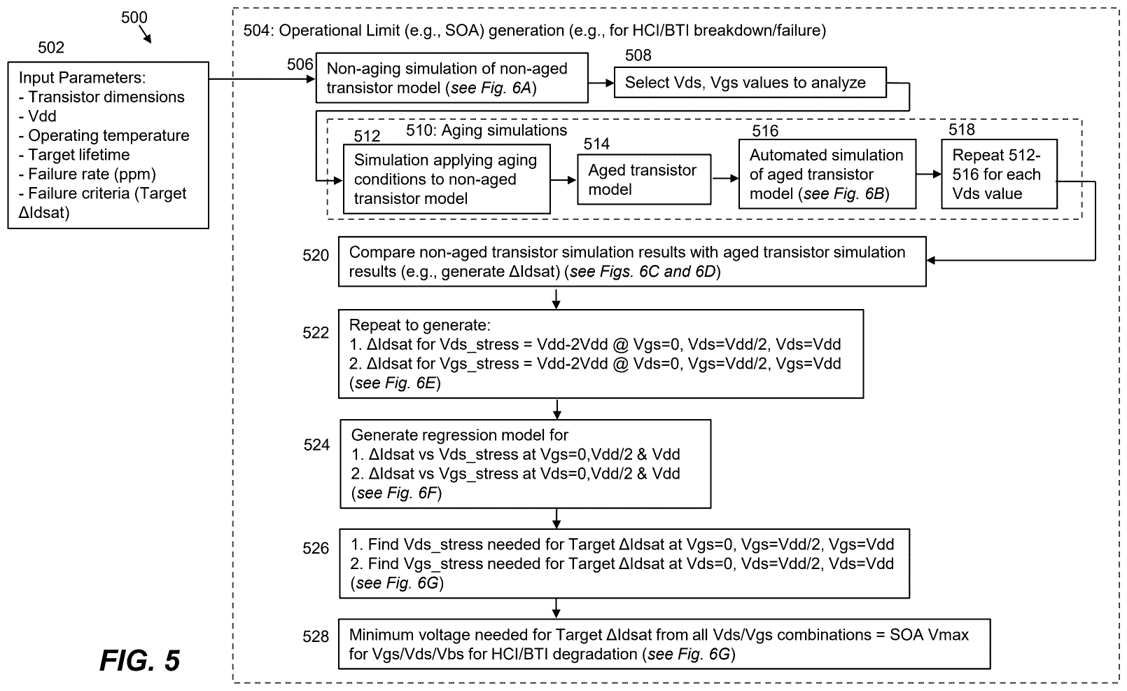

Different operational parameter value(s) (e.g., Vds, Vgs, temperature, etc.) may be used for each aging simulation of the circuit component 108, to thereby evaluate the effect of varying the operational parameter(s) on the target performance metric. For example, for a circuit component 108 comprising a transistor, each aging simulation may use a different combination of Vgs and Vds values, to evaluate the effect of varying Vgs and/or Vds on the target performance metric, e.g., as discussed below with respect to FIG. 5.

At 310, the operational limit generation system 104 may compare respective results of each aging simulation at 308 with the results of the non-aging simulation at 306, wherein the non-aging simulation at 306 represents a baseline or reference. For example, as discussed below, the operational limit generation system 104 may determine a change in performance (e.g., Idsat value) between each aging simulation and the reference non-aging simulation.

At 312, the operational limit generation system 104 may determine an operational limit 110 (e.g., maximum gate voltage) for the circuit component 108 based at least on a result of the age-dependent analysis of the circuit component 108. For example, the operational limit generation system 104 may determine from the various comparisons at 310 a lowest voltage that may violate a performance requirement specified by the input parameters 210 (e.g., maximum drop in Idsat), and set such lowest voltage as the maximum gate voltage (i.e., operational limit 110) for the circuit component 108.

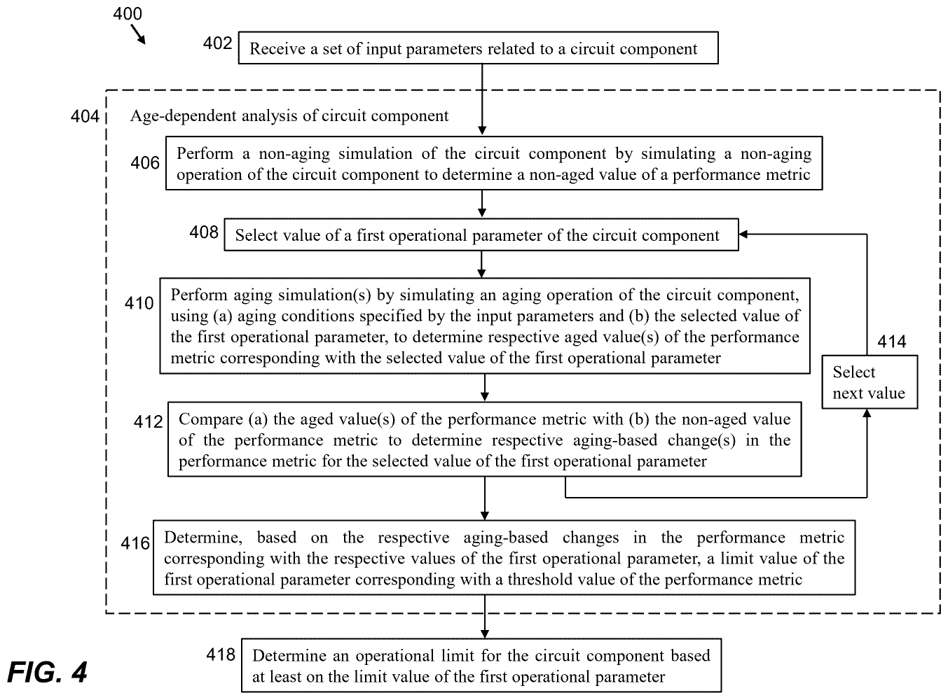

FIG. 4 shows a flowchart of another example process 400 for generating an operational limit (e.g., maximum operating voltage) for a circuit component (e.g., transistor). The example process 400 may be implemented by the operational limit generation system 104 shown in FIG. 2, for example by execution of respective logic instructions 202 (e.g., software) by a processor 206.

At 402 (similar to 302 discussed above), the operational limit generation system 104 may receive a set of input parameters 210 related to a particular circuit component 108, e.g., a particular transistor to be included in a circuit design 106 for a particular application.

At 404, the operational limit generation system 104 may perform an age-dependent analysis of the circuit component 108 based on the set of input parameters 210. The age-dependent analysis may include steps 406-416, which may be performed in any order and may be performed at least partially simultaneously.

At 406, the operational limit generation system 104 may perform a non-aging simulation of the circuit component 108 by simulating a non-aging operation of the circuit component 108, for example, based on one or more of the input parameters 210, for example using a SPICE circuit simulator program. As discussed above, simulating a non-aging operation of the circuit component 108 may include (a) generating non-aged model of the circuit component 108 based on respective input parameters 210 (e.g., dimensions, materials, operating specifications, etc. of the circuit component 108), and (b) operating the non-aged model according to respective input parameters 210 (e.g., Vdd, use temperature, etc.), and without considering time-based degradation (i.e., aging) of the circuit component 108, to determine a resulting value of a target performance metric (e.g., a saturation current Idsat) specified by the input parameters 210.

At 408-412, the operational limit generation system 104 may analyze a first operational parameter of the circuit component 108 (e.g., Vds) to generate data for determining a limit value of the first operational parameter at 416.

At 408, the operational limit generation system 104 may select a first value of the first operational parameter (e.g., Vds=Vdd, wherein Vdd is specified by the input parameters 210).

At 410, the operational limit generation system 104 may perform one or more aging simulations of the circuit component 108 using the first value of the first operational parameter (e.g., Vds=Vdd). Each aging simulation may comprise an extended simulation of an aging operation of the circuit component 108 based on (a) aging conditions specified by the input parameters and (b) the first value of the first operational parameter (e.g., Vds=Vdd), to determine a value of the target performance metric (e.g., a saturation current Idsat) resulting from such simulated operation.

In some examples, multiple aging simulations are performed using the first value of the first operational parameter (e.g., Vds=Vdd), for example using a different value of a second operational parameter (e.g., Vgs) for each respective aging simulation. Thus, each aging simulation at 410 may use (a) aging conditions specified by the input parameters, (b) the first value of the first operational parameter (e.g., Vds=Vdd), and (c) a different value of the second operational parameter (e.g., Vgs=0, Vgs=Vdd/2, and Vgs=Vdd for three distinct aging simulations), to determine respective value of the target performance metric (e.g., Idsat) resulting from such simulated operation. Vds and Vgs values applied during an aging simulation may be referred to herein as Vds_stress and Vgs_stress, respectively.

In some examples, the operational limit generation system 104 may use a SPICE circuit simulator program or other suitable program(s) for each aging simulation, wherein the first value of the first operational parameter (e.g., Vds=Vdd) and the respective value of the second operational parameter (e.g., Vgs=0, Vdd/2, or Vdd) for the target lifetime specified by the input parameters 210, which may alter certain characteristics of the circuit component 108 (e.g., gate oxide charge, electron/hole mobility, etc.). The simulator program (e.g., SPICE) may then generate an aged model of the circuit component 108 based on the altered characteristics of the circuit component 108, and operate the aged model to determine a respective value of the target performance metric (e.g., Idsat).

At 412, the operational limit generation system 104 may compare respective results of each aging simulation at 410 with the results of the non-aging simulation at 406, wherein the non-aging simulation at 406 represents a baseline or reference. For example, the operational limit generation system 104 may determine a change in performance (e.g., ΔIdsat) between each aging simulation and the reference non-aging simulation.

The operational limit generation system 104 may then select a next value (e.g., a second value) for the first operational parameter (e.g., Vds=1.2*Vdd) and repeat the process of 410 and 412. The operational limit generation system 104 may continue this process for all values of the first operational parameter to be tested, for example for a range of values of Vds from Vdd to 2*Vdd.

At 416, the operational limit generation system 104 may determine a limit value for the first operational parameter based on the results of the analysis at 408-414, for example based on the respective change in the performance metric (e.g., ΔIdsat) resulting from each iteration, i.e., the ΔIdsat resulting from each selected combination of Vds and Vgs values.

At 416, the operational limit generation system 104 may determine an operational limit 110 of the circuit component (e.g., maximum gate voltage of a transistor) based at least on the limit value determined at 416. For example, as discussed below with reference to FIG. 5, the operational limit generation system 104 may repeat the age-dependent analysis at 404 for additional operational parameter(s) (e.g., the second operational parameter (Vgs)) and determine respective limit value(s) for such operational parameter(s), which may be compared with the limit value for the first operational parameter (Vds) to determine the operational limit 110 of the circuit component, e.g., by selecting the lowest determined limit value.

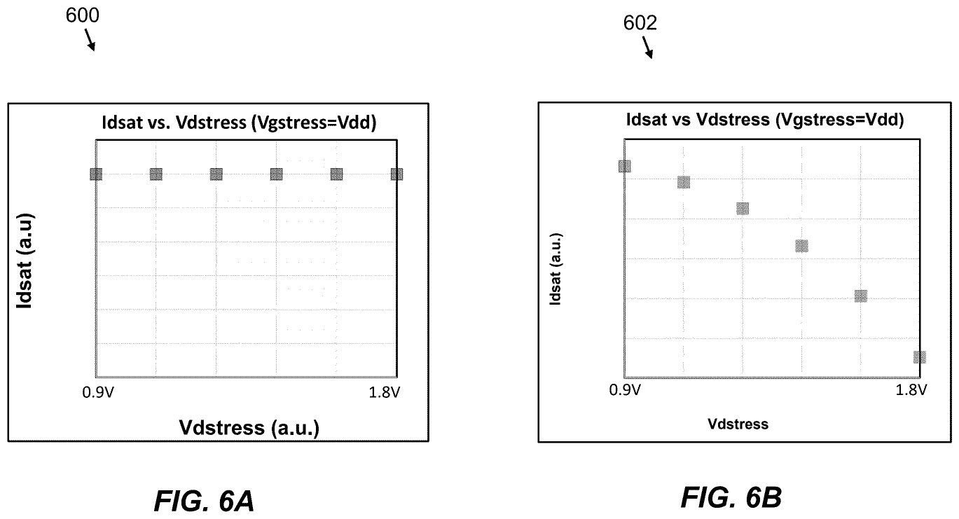

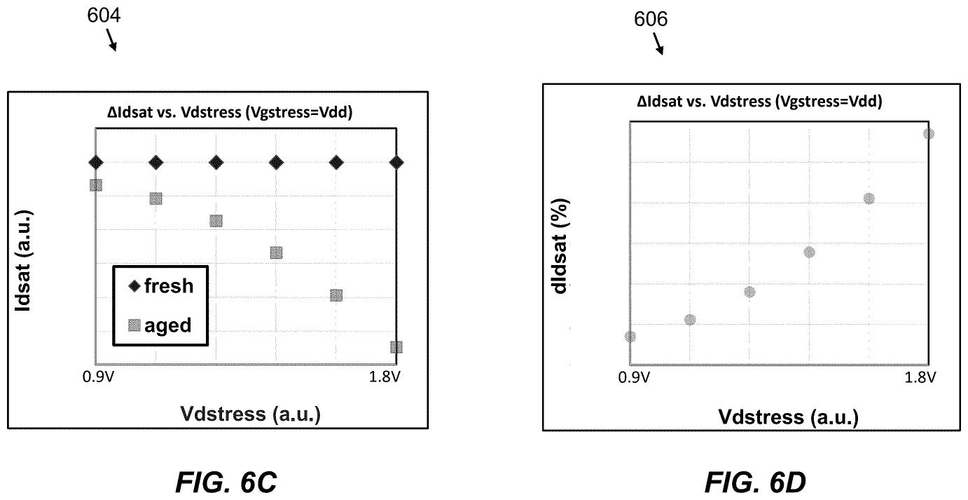

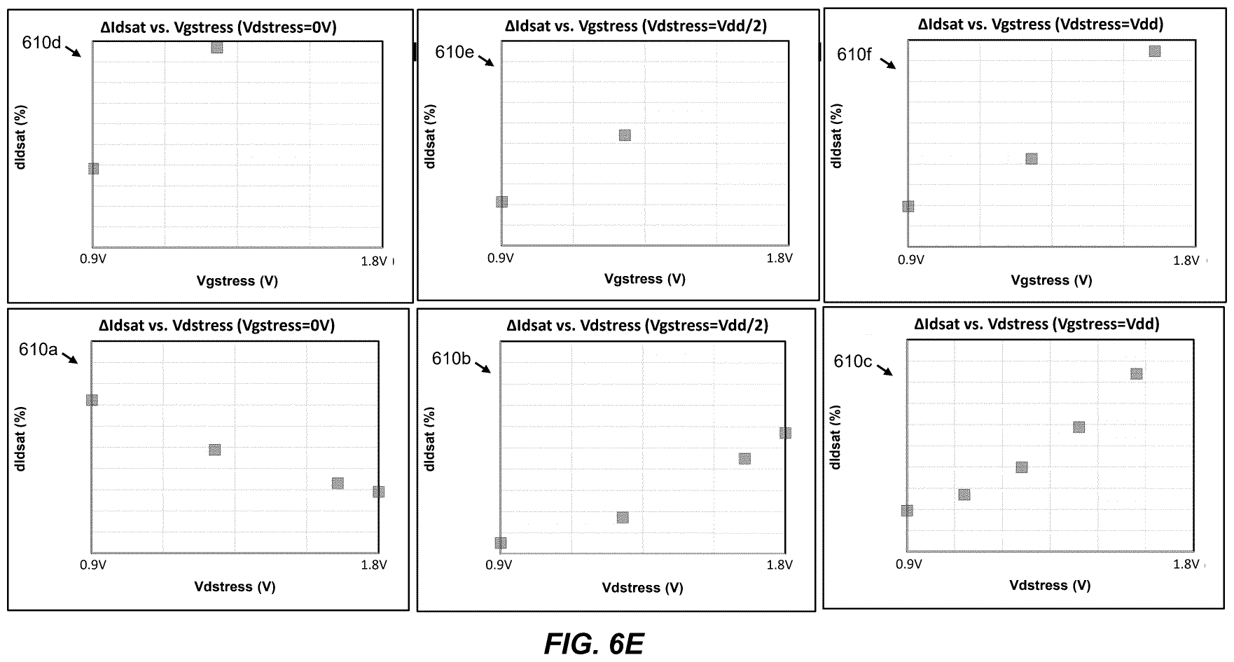

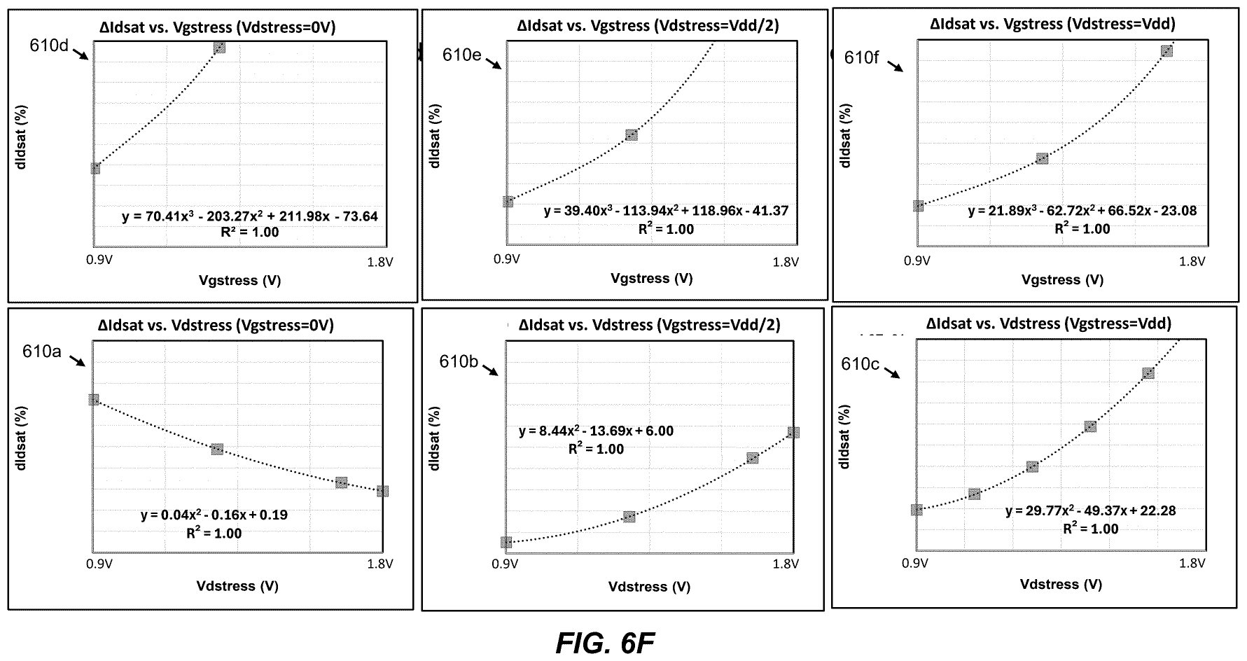

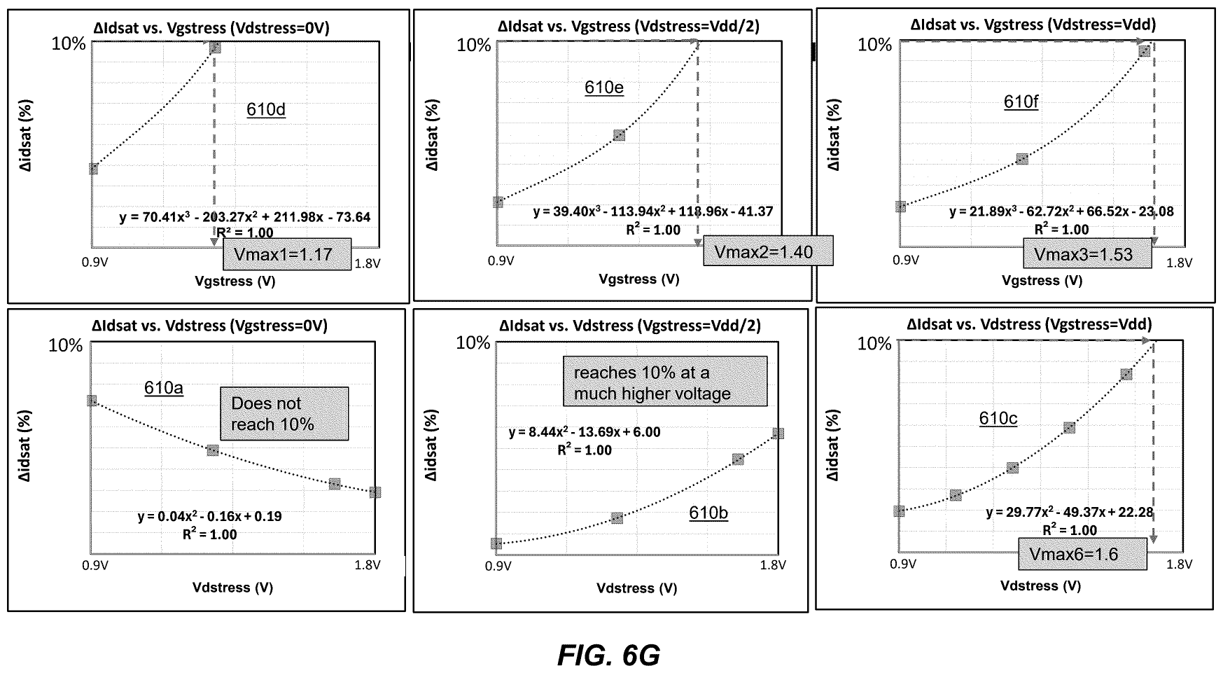

FIG. 5 shows a flowchart of an example process 500 for determining an operational limit (Vₘₐₓ) for an example transistor. The example process 500 may be at least partially implemented by the operational limit generation system 104 shown in FIG. 2, for example by execution of respective logic instructions 202 (e.g., software) by a processor 206. FIGS. 6A-6G discussed below show details of one example implementation of the example method 500, to facilitate an understanding of method 500. The discussion of method 500 below is directed to the example transistor simulation disclosed in FIGS. 6A-6G; however, it should be understood the transistor is one example only, such that method 500 may be similarly applied to other circuit components.

In some examples, the example process 500 outputs a value of Vₘₐₓ that is adopted as the operational limit (Vₘₐₓ) for the transistor. In other examples, the example process 500 outputs a value of Vₘₐₓ that is compared with at least one other value of Vₘₐₓ output by other process(es) to determine the operational limit (Vₘₐₓ) for the transistor. For example, in an example in which process 500 accounts for HCI and BTI degradation effects, but not TDDB degradation effects, a value of Vₘₐₓ output by process 500 may be compared with another value of Vₘₐₓ output by a separate process that analyzes TDDB degradation, and the lower value of the Vₘₐₓ may be selected as the operational limit (Vₘₐₓ) for the transistor.

At 502, the operational limit generation system 104 may receive a set of input parameters 210 related to the example transistor. For example, the set of input parameters 210 may specify:
(a) dimensions of the transistor (e.g., width=10 microns, length=100 nm),
(b) maximum operating voltage Vdd=0.9V,
(c) maximum operating temperature of the circuit component=125° C. (e.g., maximum junction temperature of transistor),
(d) target lifetime=10 years,
(e) target failure rate=1000 ppm, and
(f) failure criteria=10% change (degradation) in saturation current (ΔIdsat).

In other examples, the failure criteria may specify a maximum change in linear drain current (Idlin) (e.g., ΔIdlin=10%) or linear threshold voltage (Vtlin) (e.g., ΔVtlin=10%), or alternatively the input parameters 210 may specify multiple alternative failure criteria, for example, ΔIdsat=10% ΔIdlin=10%, or ΔVtlin=10%.

At 504, the operational limit generation system 104 performs an operational limit generation process to generate an operational limit for the transistor with respect to respective failure modes, in particular failures from hot carrier injection (HCI) degradation or bias temperature instability (BTI). (As discussed below, a separate process may be used to generate an operational limit for the transistor with respect to respective other modes (e.g., TDDB) and the different operational limits may be compared to select one operational limit value for the transistor).

At 506, the operational limit generation system 104 may perform a non-aging simulation of the transistor by simulating a non-aging operation of the circuit component 108, for example, based on one or more of the input parameters 210, for example using a SPICE circuit simulator program. As discussed above, simulating a non-aging operation of the circuit component 108 may include (a) generating non-aged model of the circuit component 108 based on respective input parameters 210 (e.g., dimensions, materials, operating specifications, etc. of the circuit component 108), and (b) operating the non-aged model according to respective input parameters 210 (e.g., Vdd, use temperature, etc.), and without considering time-based degradation (i.e., aging) of the circuit component 108, to determine a resulting value of a target performance metric specified by the input parameters 210 (e.g., in this example, Idsat).

FIG. 6A illustrates a graph 600 showing an example result (Idsat versus Vds) of the non-aging simulation, wherein Idsat is measured using Vds=Vgs=Vdd (0.9V in this example). Although the simulation is only performed for Vds=0.9V, the resulting Idsat value is applied to each other value of Vds, to provide a baseline for comparison with Idsat values resulting from aging simulations, as discussed below.

At 508, the operational limit generation system 104 may start by selecting values of Vds and Vgs to analyze, for example by selecting Vds to analyze through a range of Vds values from Vdd to 2*Vdd, and using a selected Vgs value (Vgs=Vdd).

At 510, the operational limit generation system 104 may perform aging simulations of the transistor using the parameter values selected at 508. First, at 512, the operational limit generation system 104 may simulate (e.g., using SPICE) an operation of the non-aged model generated at 506 for a first value of Vds in the specified range of Vdd to 2*Vdd, and using Vgs=0. For example, the operational limit generation system 104 may perform a first simulation using Vds=Vdd and Vgs=0, applied for the target lifetime of 10 years.

The simulation at 512 alters certain characteristics of the transistor, e.g., gate oxide charge, electron/hole mobility, etc. At 514, the simulator program (e.g., SPICE) may generate an aged model of the transistor based on such altered characteristics of the transistor.

At 516, the operational limit generation system 104 may then operate the aged model using Vds=Vgs=Vdd (0.9V in this example) to determine a respective Idsat value.

At 518, the operational limit generation system 104 may repeat the process of 512-516 for each other value of Vds, for example Vds=1.2*Vdd, Vds=1.4*Vdd, Vds=1.6*Vdd, Vds=1.8*Vdd, and Vds=2*Vdd, to determine a respective Idsat value for each value of Vds.

FIG. 6B illustrates a graph 602 showing example results (Idsat versus Vds) of the respective aging simulations for the various values of Vds Vds=1.2*Vdd, 1.4*Vdd, 1.6*Vdd, 1.8*Vdd, and 2*Vdd), with Vgs=Vdd.

At 520, the operational limit generation system 104 may compare the results (Idsat values) of the aging simulations at 510 (i.e., the Idsat values shown in FIG. 6B) with the results (Idsat value) of the non-aging simulation at 506. FIG. 6C illustrates a graph 604 showing the results of the non-aging simulation and aging simulations for Vds=Vdd to 2*Vdd (0.9-1.8V) with Vgs=Vdd. FIG. 6D illustrates a graph 606 showing ΔIdsat (change in Idsat between the aging and non-aging simulations) versus Vds.

At 522, the operational limit generation system 104 may repeat the process at 510-520 to analyze Vds values using other values of Vgs (e.g., Vgs=0 and Vgs=Vdd/2), and the process for analyzing Vds discussed above (i.e., at 510-522) may be repeated to analyze Vgs (i.e., by analyzing Vgs through a range of values from Vdd to 2*Vdd, and using selected Vds value (Vgs=0, Vdd/2, and Vdd), to generate respective ΔIdsat results for each combination of parameter values.

FIG. 6E illustrates (a) three graphs 610a-610c showing example results (ΔIdsat versus Vds) of the Vds analysis discussed above, wherein graph 610c corresponds with graph 606 shown in FIG. 6D, and (b) three graphs 610d-610f showing example results (ΔIdsat versus Vgs) of the corresponding Vgs analysis.

At 524, the operational limit generation system 104 may generate a regression model for each respective graph 610a-610f, as shown in FIG. 6F.

At 526, the operational limit generation system 104 may determine a respective limit value (Vₘₐₓ) for each graph 610a-610f using each regression models shown in FIG. 6F. For example, as shown in FIG. 6G, for graphs 610a-610c, a respective Vₘₐₓ limit value may be determined as the value of Vds (if any) for which the regression line exceeds the target ΔIdsat of 10% (specified in the input parameters received at 502). In this example, a limit value of Vₘₐₓ=1.6V is determined from graph 610c.

Similarly, for graphs 610d-610f, a respective Vₘₐₓ limit value may be determined as the value of Vgs (if any) for which the regression line exceeds ΔIdsat of 10%. In this example, as shown in FIG. 6G, limit values of Vₘₐₓ=1.17V, Vₘₐₓ=1.40V, and Vₘₐₓ=1.53V are determined from graphs 610d, 610e, and 610f, respectively.

At 528, the operational limit generation system 104 may determine a minimum limit value from the various Vₘₐₓ limit values determined at 526, in this example Vₘₐₓ=1.17 shown in graph 610d. In this example, this minimum limit value (Vₘₐₓ=1.17) may be specified as the operational voltage limit for the transistor with respect to potential hot carrier injection (HCI) degradation and/or bias temperature instability (BTI), according to the input parameters received at 502. In an example in which multiple failure criteria are specified by the input parameters, for example, ΔIdsat=10% ΔIdlin=10%, or ΔVtlin=10%, the process described above may be repeated for each respective failure criteria (e.g., ΔIdsat, ΔIdlin, and ΔVtlin) to determine respective limit values, which may be compared to determine an operational voltage limit (e.g., the lowest limit value).

In addition, as discussed above, a separate process may be used to generate an operational limit for the transistor with respect to one or more other failure modes (e.g., TDDB) and the different operational limits may be compared to select an overall operational limit for the transistor. For example, assuming a separate process determines an operational limit of 1.55V with respect to TDDB degradation, the operational limit generation system 104 may select the lower value of 1.17V (1.17V versus 1.55V) as the operational limit for the transistor.

Although example embodiments have been described above, other variations and embodiments may be made from this disclosure without departing from the spirit and scope of these embodiments.

1. A non-transitory computer-readable medium comprising instructions executable by a processor to:
receive a set of input parameters related to a circuit component;
perform an age-dependent analysis of the circuit component based on the set of input parameters, including:
performing a non-aging simulation of the circuit component by simulating a non-aging operation of the circuit component;
performing a series of aging simulations of the circuit component, each aging simulation comprising a simulation of an aging operation of the circuit component based on (a) aging conditions specified by the input parameters and (b) a different value of at least one operational parameter of the circuit component;
comparing respective results of the series of aging simulations with a result of the non-aging simulation; and
determine an operational limit for the circuit component based at least on a result of the age-dependent analysis of the circuit component.

2. The non-transitory computer-readable medium of claim 1, wherein the instructions are further executable by the processor to apply the operational limit to a circuit design to detect design violations.

3. The non-transitory computer-readable medium of claim 1, wherein the operational limit comprises a safe operating area (SOA) limit for the circuit component.

4. The non-transitory computer-readable medium of claim 1, wherein the non-aging simulation and the aging simulations of the circuit component are performed by a SPICE simulator.

5. The non-transitory computer-readable medium of claim 1, wherein each aging simulation in the series of aging simulations of the circuit component comprises a simulation of an aging operation of the circuit component based on (a) the aging conditions specified by the input parameters and (b) a different parameter value combination for at least two operational parameters of the circuit component.

6. The non-transitory computer-readable medium of claim 1, wherein:
performing the series of aging simulations of the circuit component comprises performing multiple aging simulations of the circuit component for each of multiple different values of a first operational parameter of the circuit component, wherein the multiple aging simulations for a respective value of the first operational parameter comprises respective aging simulations based on (a) the aging conditions specified by the input parameters, (b) the respective value of the first operational parameter, and (c) multiple different values of a second operational parameter of the circuit component;
the age-dependent analysis comprises determining, for each of at least two of the multiple different values of the first operational parameter, a respective limit value derived from results of the multiple aging simulations performed for the respective value of the first operational parameter; and
determining the operational limit for the circuit component based at least on a result of the age-dependent analysis of the circuit component comprises selecting a highest or lowest value of the at least two limit values as the operational limit for the circuit component.

7. The non-transitory computer-readable medium of claim 1, wherein the circuit component comprises a transistor, and the at least one operational parameter of the circuit component comprises at least one of a gate-source voltage (Vgs), a drain-source voltage (Vds), or a body-source voltage (Vbs).

8. The non-transitory computer-readable medium of claim 1, wherein:
the non-aging simulation of the circuit component comprises simulating an effect of the non-aging operation of the circuit component on a performance metric specified in the set of input parameters; and
each respective aging simulation of the circuit component comprises simulating an effect of the aging operation of the circuit component on the specified performance metric.

9. The non-transitory computer-readable medium of claim 8, wherein:
the circuit component comprises a transistor;
the at least one operational parameter of the circuit component comprises at least one of a gate-source voltage (Vgs), a drain-source voltage (Vds), or a body-source voltage (Vbs); and
the specified performance metric comprise a saturation drain current (Idsat), a linear drain current (Idlin), or a linear threshold voltage (Vtlin).

10. The non-transitory computer-readable medium of claim 1, wherein:
performing the non-aging simulation of the circuit component comprises simulating a non-aging operation of a non-aged model of the circuit component derived from the set of input parameters;
performing a respective aging simulation of the circuit component in the series of aging simulations comprises:
simulating an aging operation of the non-aged model of the circuit component;
generating an aged model of the circuit component based on results of the simulated aging operation of the non-aged model of the circuit component; and
simulating an operation of the aged model of the circuit component.

11. A non-transitory computer-readable medium comprising instructions executable by a processor to:
receive a set of input parameters related to a transistor;
perform an age-dependent analysis of the transistor, including:
performing a non-aging simulation of the circuit component by simulating a non-aging operation of the circuit component to determine a non-aged value of a performance metric;
performing a series of aging simulations of the circuit component, wherein performing each respective aging simulation in the series of aging simulations comprises simulating an aging operation of the circuit component, using (a) aging conditions specified by the input parameters and (b) a respective value of multiple different values of a first operational parameter of the circuit component, to determine a respective aged value of the performance metric corresponding with the respective value of the first operational parameter;
for each respective aging simulation, comparing (a) the respective aged value of the performance metric corresponding with the respective value of the first operational parameter with (b) the non-aged value of a performance metric to determine a respective aging-based change in the performance metric corresponding with the respective value of the first operational parameter;
determining, based on the respective aging-based changes in the performance metric corresponding with the respective values of the first operational parameter, a limit value of the first operational parameter corresponding with a threshold value of the performance metric; and
determine an operational limit for the circuit component based at least on the determined limit value of the first operational parameter.

12. The non-transitory computer-readable medium of claim 11, wherein the instructions are further executable by the processor to apply the operational limit to a circuit design to detect design violations.

13. The non-transitory computer-readable medium of claim 11, wherein the operational limit comprises a safe operating area (SOA) limit for the circuit component.

14. The non-transitory computer-readable medium of claim 11, wherein:
performing the series of aging simulations of the circuit component comprises performing multiple aging simulations of the circuit component for each of the multiple different values of the first operational parameter of the circuit component, wherein the multiple aging simulations for the respective value of the first operational parameter comprises respective aging simulations based on (a) the aging conditions specified by the input parameters, (b) the respective value of the first operational parameter, and (c) multiple different values of a second operational parameter of the circuit component;
the age-dependent analysis comprises determining, for each of at least two of the multiple different values of the first operational parameter, a respective limit value derived from results of the multiple aging simulations performed for the respective value of the first operational parameter; and
determining the operational limit for the circuit component based at least on a result of the age-dependent analysis of the circuit component comprises selecting a highest or lowest value of the at least two limit values as the operational limit for the circuit component.

15. The non-transitory computer-readable medium of claim 11, wherein the circuit component comprises a transistor, and the first operational parameter comprises a gate-source voltage (Vgs), a drain-source voltage (Vds), or a body-source voltage (Vbs).

16. The non-transitory computer-readable medium of claim 11, wherein:
the non-aging simulation of the circuit component comprises simulating an effect of the non-aging operation of the circuit component on a performance metric specified in the set of input parameters; and
each respective aging simulation of the circuit component comprises simulating an effect of the aging operation of the circuit component on the specified performance metric.

17. The non-transitory computer-readable medium of claim 16, wherein:
the circuit component comprises a transistor;
the first operational parameter of the circuit component comprises a gate-source voltage (Vgs), a drain-source voltage (Vds), or a body-source voltage (Vbs); and
the specified performance metric comprise a saturation drain current (Idsat), a linear drain current (Idlin), or a linear threshold voltage (Vtlin).

18. A method, comprising:
receiving a set of input parameters related to a circuit component;
performing an age-dependent analysis of the circuit component based on the set of input parameters, including:
performing a non-aging simulation of the circuit component by simulating a non-aging operation of the circuit component;
performing a series of aging simulations of the circuit component, each aging simulation comprising a simulation of an aging operation of the circuit component based on (a) aging conditions specified by the input parameters and (b) a different value of at least one operational parameter of the circuit component;
comparing respective results of the series of aging simulations with a result of the non-aging simulation; and
determining an operational limit for the circuit component based at least on a result of the age-dependent analysis of the circuit component.

19. The method of claim 18, wherein:
performing the series of aging simulations of the circuit component comprises performing multiple aging simulations of the circuit component for each of multiple different values of a first operational parameter of the circuit component, wherein the multiple aging simulations for a respective value of the first operational parameter comprises respective aging simulations based on (a) the aging conditions specified by the input parameters, (b) the respective value of the first operational parameter, and (c) multiple different values of a second operational parameter of the circuit component;
the age-dependent analysis comprises determining, for each of at least two of the multiple different values of the first operational parameter, a respective limit value derived from results of the multiple aging simulations performed for the respective value of the first operational parameter; and
determining the operational limit for the circuit component based at least on a result of the age-dependent analysis of the circuit component comprises selecting a highest or lowest value of the at least two limit values as the operational limit for the circuit component.

20. A system, comprising:
an electronic design automation (EDA) tool for facilitating a development of circuit design including a circuit component;
an operational limit generation system integrated in the EDA tool, the operational limit generation system including instructions stored in non-transitory computer-readable medium and executable by a processor to:
receive a set of input parameters related to a circuit component;
perform an age-dependent analysis of the circuit component based on the set of input parameters, including:
performing a non-aging simulation of the circuit component by simulating a non-aging operation of the circuit component;
performing a series of aging simulations of the circuit component, each aging simulation comprising a simulation of an aging operation of the circuit component based on (a) aging conditions specified by the input parameters and (b) a different value of at least one operational parameter of the circuit component;
comparing respective results of the series of aging simulations with a result of the non-aging simulation; and
determine an operational limit for the circuit component based at least on a result of the age-dependent analysis of the circuit component.
